(19) United States
(12) Patent Application Publication
(10) Pub. No.: US 2012/0005336 A1
(43) Pub. Date: Jan. 5, 2012

(54) INFORMATION PROCESSING SYSTEM, INFORMATION PROCESSING APPARATUS, CONTROL METHODS THEREFOR, AND COMPUTER PROGRAMS

(75) Inventor: Hideaki Ooba, Sagamihara-shi (JP)

(73) Assignee: CANON KABUSHIKI KAISHA, Tokyo (JP)

(21) Appl. No.: 13/151,949

(22) Filed: Jun. 2, 2011

(30) Foreign Application Priority Data
Jul. 5, 2010 (JP) 2010-153481

(51) Int. Cl. G06F 15/173

(52) U.S. Cl. 709/224

(57) ABSTRACT

Provided are an information processing system that detects a firewall between an MFP and a Web server, and changes a network connection method depending on whether a firewall exists, and a control method therefor. To accomplish this, this information processing system includes an image processing apparatus and an information processing apparatus connected via a network. The image processing apparatus requests the information processing apparatus for existence/absence information indicating whether a firewall exists on a communication path between the image processing apparatus and the information processing apparatus. The information processing apparatus detects whether a firewall exists on the communication path between the image processing apparatus and the information processing apparatus, adjusts a communication method so as to employ a first communication method if a firewall exists and so as to employ a second communication method if a firewall does not exist, and notifies the image processing apparatus of the result.

### BACKGROUND OF THE INVENTION

1. Field of the Invention

The present invention relates to an information processing system including a Web server that is an information processing apparatus and an image processing apparatus provided with a Web browser that displays an operation screen provided from the Web server, an information processing apparatus, control methods therefor, and computer programs.

2. Description of the Related Art

Connecting an information processing apparatus such as a PC to a Web server on a network, and displaying an operation screen provided by the Web server on a Web browser provided in the information processing apparatus is known. In this case, first, the Web browser of the information processing apparatus requests the Web server for an operation screen. After that, in response to the request from the information processing apparatus, a Web application on the Web server transmits an HTML file to cause the Web browser to display an operation screen to the information processing apparatus. The Web browser for the information processing apparatus analyzes the received HTML file, and displays an operation screen based on the description of the HTML file. Moreover, if a user inputs an instruction via the operation screen displayed by the Web browser, the Web browser notifies the Web server of the input instruction. Then, the Web application on the Web server that has received this notification executes processing in accordance with the input instruction.

Recently some MFPs (Multi Function Peripherals) provided with a scanner and a printer are also provided with a web browser as described above. Such an MFP displays an operation screen provided by the Web server on the Web browser of the MFP using the procedure described above, and accept various instructions from a user.

Japanese Patent Laid-Open No. 2006-127503 proposes technology of a Web server providing an operation screen for inputting instructions for utilizing functions with which an MFP is provided. Specifically, a user of the MFP inputs an instruction to the MFP. Then, a Web browser of the MFP notifies the Web server of the input instruction as a request. The Web server that has received this notification creates a script in which various processes are described for the MFP based on the input instruction. The Web server notifies the MFP of the created script as a response to the above request from the Web browser. The MFP executes the script by passing the script from the Web browser to a script processing unit, and a function of the MFP is utilized. Similarly, Japanese Patent Laid-Open No. 2008-003833 proposes technology of a Web browser executing a screen display script, this being different from Japanese Patent Laid-Open No. 2006-127503. Specifically, a function of the device is utilized by invoking a Web service for processing the function of the MFP in that script.

Technology for a communication form differing from those in Japanese Patent Laid-Open No. 2006-127503 and Japanese Patent Laid-Open No. 2008-003833 is also being considered. In that technology, a Web server does not return a created script as a response to a request, unlike Japanese Patent Laid-Open No. 2006-127503 and Japanese Patent Laid-Open No. 2008-003833, but rather establishes another network connection for script submission with an MFP and transmits the script in this connection. The difference between this technology and those in Japanese Patent Laid-Open No. 2006-127503 and Japanese Patent Laid-Open No. 2008-003833 is that a script can be submitted to the MFP under the lead of the Web server, such as cancelling a job of the MFP from the Web server. Moreover, the operation of the MFP can be checked under the lead of the Web server when, for instance, the Web server wants to obtain the condition of the MFP, other than when script submission is performed. Accordingly, it is possible to operate the MFP in a timelier manner than with the methods disclosed in Japanese Patent Laid-Open No. 2006-127503 and Japanese Patent Laid-Open No. 2008-003833.

However, the above conventional technologies have the following problems. For example, in the communication form that differs from those in Japanese Patent Laid-Open No. 2006-127503 and Japanese Patent Laid-Open No. 2008-003833 described above, there is a problem that a network connection for submitting a script from the Web server to the MFP is difficult if a firewall exists on the network between the MFP and the Web server. An example thereof is a case where the MFP is connected to a local network in a company, and the Web server is located on the Internet. In the case where the MFP connects to the Web server in this example, normally, connection is possible since the connection is from inside the firewall. However, in the case where the Web server connects to the MFP, since the connection is from outside the firewall to inside, normally, this connection is blocked by the firewall, and thus communication is not possible. Accordingly, the Web server cannot submit a script to the MFP.

On the other hand, in the technologies described in Japanese Patent Laid-Open No. 2006-127503 and Japanese Patent Laid-Open No. 2008-003833, the Web server only returns information as a response to an access (request) from the MFP (Web browser) side, and even if a firewall exists, the response will not be blocked by the firewall. However, after transmitting a script to the Web browser once, a Web application needs to wait for a next request from the Web browser until the end of processing, and thus timely processing cannot be performed.

### SUMMARY OF THE INVENTION

The present invention enables realization of an information processing system that detects a firewall between an MFP and a Web server, and changes a network connection method depending on whether a firewall exists, and a control method therefor.

One aspect of the present invention provides an information processing system comprising an image processing apparatus and an information processing apparatus that are connected via a network, the image processing apparatus including: a request unit that requests the information processing apparatus for existence/absence information that indicates whether a firewall exists on a communication path between the image processing apparatus and the information processing apparatus, and the information processing apparatus including: a detection unit that detects whether a firewall exists on the communication path between the image processing apparatus and the information processing apparatus, in response to the request from the request unit; an adjustment unit that adjusts a communication method so as to employ a first communication method in which the information processing apparatus issues an instruction as a response to a request from the image processing apparatus in a case where a detection result obtained by the detection unit indicates that the firewall exists, and so as to employ a second communication method in which the information processing apparatus issues an instruction without needing a request from the image processing apparatus in a case where the detection result does not indicate that the firewall exists; and a notification unit that notifies the image processing apparatus of the communication method adjusted by the adjustment unit and the existence/absence information.

Another aspect of the present invention provides an information processing apparatus connected to an image processing apparatus via a network, the information processing apparatus comprising: a detection unit that detects whether a firewall exists on a communication path between the image processing apparatus and the information processing apparatus, in response to a request from the image processing apparatus; an adjustment unit that adjusts a communication method so as to employ a first communication method in which the information processing apparatus issues an instruction as a response to a request from the image processing apparatus in a case where a detection result obtained by the detection unit indicates that the firewall exists, and so as to employ a second communication method in which the information processing apparatus issues an instruction without needing a request from the image processing apparatus in a case where the detection result does not indicate that the firewall exists; and a notification unit that notifies the image processing apparatus of the communication method adjusted by the adjustment unit and existence/absence information that indicates whether a firewall exists on the communication path between the image processing apparatus and the information processing apparatus.

Still another aspect of the present invention provides a control method for an information processing system including an image processing apparatus and an information processing apparatus that are connected via a network, the method comprising: a request unit of the image processing apparatus requesting the information processing apparatus for existence/absence information that indicates whether a firewall exists on a communication path between the image processing apparatus and the information processing apparatus; a detection unit of the information processing apparatus detecting whether a firewall exists on the communication path between the image processing apparatus and the information processing apparatus, in response to the request in the requesting; an adjustment unit of the information processing apparatus adjusting a communication method so as to employ a first communication method in which the information processing apparatus issues an instruction as a response to a request from the image processing apparatus in a case where a detection result obtained in the detecting indicates that the firewall exists, and so as to employ a second communication method in which the information processing apparatus issues an instruction without needing a request from the image processing apparatus in a case where the detection result does not indicate that the firewall exists; and a notification unit of the information processing apparatus notifying the image processing apparatus of the communication method adjusted in the adjusting and the existence/absence information.

Yet still another aspect of the present invention provides a control method for an information processing apparatus connected to an image processing apparatus via a network, the method comprising: a detection unit detecting whether a firewall exists on a communication path between the image processing apparatus and the information processing apparatus, in response to a request from the image processing apparatus; an adjustment unit adjusting a communication method so as to employ a first communication method in which the information processing apparatus issues an instruction as a response to a request from the image processing apparatus in a case where a detection result obtained in the detecting indicates that the firewall exists, and so as to employ a second communication method in which the information processing apparatus issues an instruction without needing a request from the image processing apparatus in a case where the detection result does not indicate that the firewall exists; and a notification unit notifying the image processing apparatus of the communication method adjusted in the adjusting and existence/absence information that indicates whether a firewall exists on the communication path between the image processing apparatus and the information processing apparatus.

Still yet another aspect of the present invention provides a computer-readable storage medium storing a computer program for causing a computer to execute the control method for the information processing system.

Yet still another aspect of the present invention provides a computer-readable storage medium storing a computer program for causing a computer to execute the control method for the information processing apparatus.

Further features of the present invention will be apparent from the following description of exemplary embodiments with reference to the attached drawings.

### BRIEF DESCRIPTION OF THE DRAWINGS

FIG. 1 is a diagram showing an example of a configuration of an information processing system according to an embodiment of the present invention.

FIG. 2 is a block diagram showing examples of configurations of an MFP and a Web server according to the embodiment of the present invention.

FIG. 3 is a diagram showing examples of software configurations of the MFP and the Web server according to the embodiment of the present invention.

FIG. 4 is a sequence diagram of communication processing according to a first embodiment.

FIG. 5 is a flowchart of firewall detection according to the embodiment of the present invention.

FIG. 6 is a diagram showing an example of a setting UI by a Web browser according to the embodiment of the present invention.

FIG. 7 is a sequence diagram of the communication processing according to the first embodiment.

FIG. 8 is a sequence diagram of communication processing according to a second embodiment.

FIG. 9 is a diagram showing an example of a firewall setting UI according to a third embodiment.

### DESCRIPTION OF THE EMBODIMENTS

Embodiments of the present invention will now be described in detail with reference to the drawings. It should be noted that the relative arrangement of the components, the numerical expressions and numerical values set forth in these embodiments do not limit the scope of the present invention unless it is specifically stated otherwise.

Configuration of Information Processing System

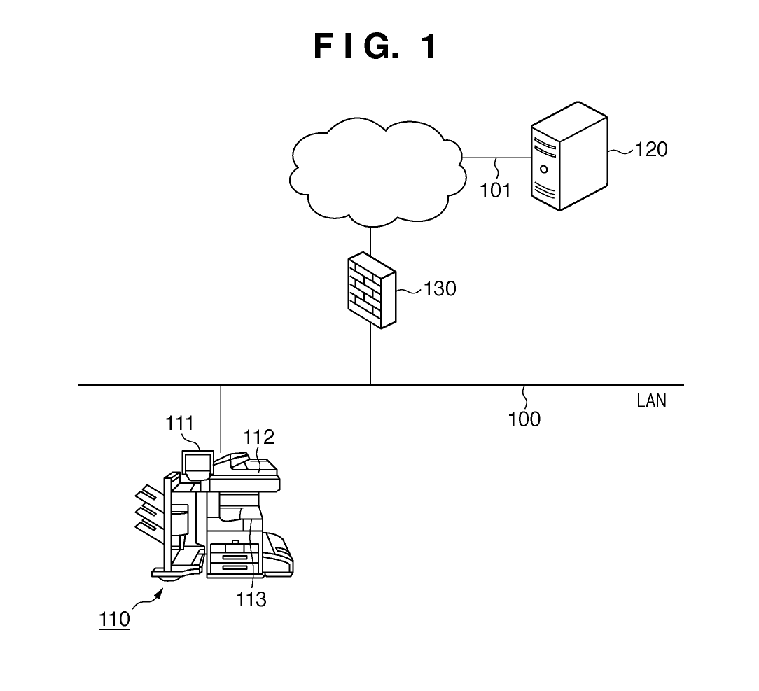

First is a description of an overall configuration of an information processing system to which the present invention is applicable, with reference to FIG. 1. As shown in FIG. 1, an MFP 110 that is an image processing apparatus is connected to a LAN 100 composed of Ethernet (registered trademark) or the like. The information processing system according to the present invention includes the MFP 110 and a Web server 120, for example. The MFP 110 has a copy function, a scanner function, and a data transmission function, for example. The data transmission function is a function of reading an original image using the scanner function, and transmitting the obtained image data to a designated apparatus on the LAN 100 or the Internet using the FTP protocol, the SMB protocol, or the like. Further, an e-mail can be created with image data as an attached file, and transmitted utilizing an e-mail server (not shown).

The Web server 120 is a server that exists on the Internet. The LAN 100 and the Internet are connected via a firewall 130. The firewall 130 is a server that restricts access from the Internet to the LAN 100 and access from the LAN 100 to the Internet. In the present embodiment, a description is given assuming that access from the Internet to the LAN 100 is prohibited, and access from the MFP 110 on the LAN 100 to the Web server 120 on the Internet or a connection to a service provided by the Web server 120 is permitted.

The Web server 120 is an information processing apparatus, and is connected to an LAN/WAN 101 composed of Ethernet (registered trademark) or the like. In response to a request from the MFP 110, a Web application that is software operating on the Web server 120 transmits HTML data to be displayed on an operation unit 111 of the MFP 110.

However, the information processing system according to the present embodiment is not limited by the number of these constituent devices, and the setting of a firewall. Further, although a LAN is applied as a connection method in the present embodiment, the present invention is not limited thereto, and for example, an arbitrary network such as a WAN (public network), a serial transmission system such as a USB, a parallel transmission system such as Centronics or SCSI, or the like is also applicable.

Hardware Configuration of MFP 110 and Web Server 120

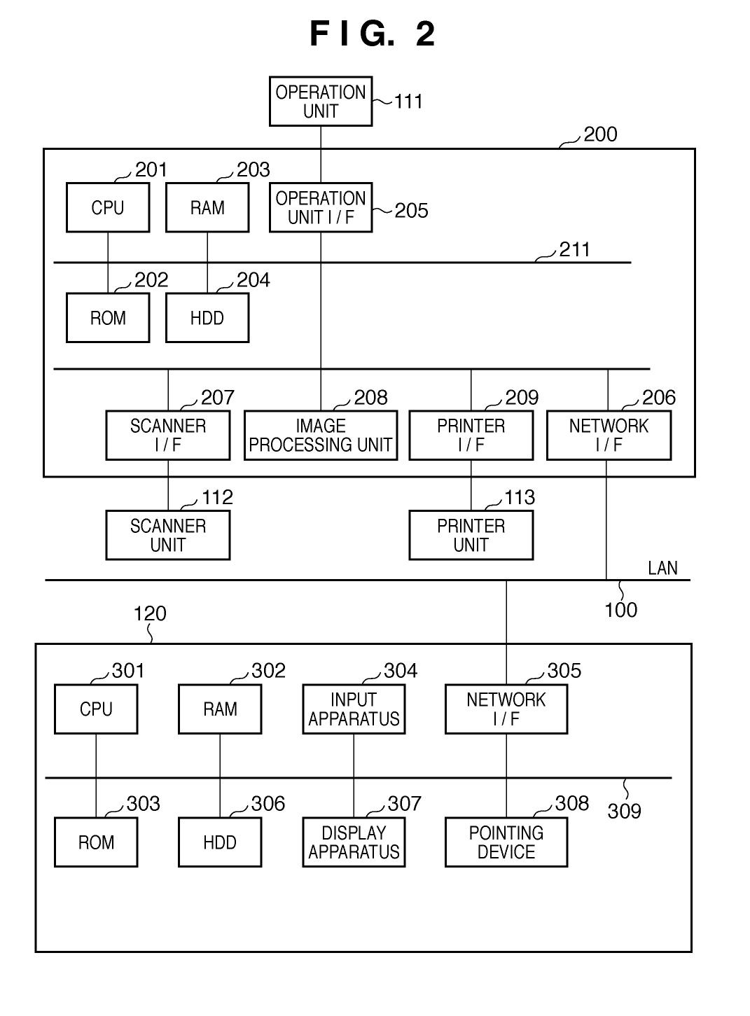

Next is a description of the hardware configuration of the MFP 110 and the Web server 120 of the present invention, with reference to FIG. 2. First is a description of the hardware configuration of the MFP 110. The MFP 110 is provided with a scanner unit 112 that is an image input MFP, a printer unit 113 that is an image output device, a controller 200 that controls the MFP 110, and an operation unit 111. Note that although the MFP 110 is a network MFP that executes UI display in the present embodiment, the MFP may be an image processing apparatus other than this, such as a general purpose computer to which a general purpose scanner, a general purpose printer, and the like are connected.

The scanner unit 112 is a device that reads an image on an original and generates image data. Note that the controller 200 gives an instruction to the scanner unit 112 to read originals set in an original feeder. Upon receipt of this instruction, the scanner unit 112 feeds the originals one by one from the original feeder, and performs an original reading operation. Note that the original reading method may be a method in which an original is placed on a glass surface (not shown) and scanned by moving an exposing unit, rather than the method of automatic feeding performed by the original feeder.

The printer unit 113 is an image forming device that forms image data received from the controller 200 as an image on a sheet. Note that other than an electrophotographic image forming method using a photosensitive drum and a photosensitive belt, an inkjet image forming method is also applicable in the present embodiment.

The controller 200 is electrically connected to the operation unit 111, the scanner unit 112, and the printer unit 113, and is also connected to the LAN 100 via a network I/F (interface) 206. Specifically, the controller 200 is connected to other devices via the LAN 100. This enables communication based on the HTTP protocol.

A CPU 201 performs overall control of access to various connected devices and access from other devices based on a control program stored in a ROM 202, or the like. At the same time, the CPU 201 also performs overall control of various processes performed in the controller 200. This control also includes execution of a program for realizing a flowchart that will be described later. In addition to the above control program, a boot program of the apparatus is also stored in the ROM 202.

A RAM 203 is a system work memory for the CPU 201 to operate, and is a memory for temporarily storing image data. The RAM 203 is constituted by a region where stored content is held using power backup or the like even after the power of the apparatus main body is turned off, and a region where stored content will be erased after the power is turned off. An HDD 204 is a hard disk drive, and can store system software and image data.

An operation unit I/F 205 is an interface unit for connecting a system bus 211 and the operation unit 111. The operation unit I/F 205 receives image data to be displayed on the operation unit 111 from the system bus 211, and outputs the received data to the operation unit 111, and also outputs information input from the operation unit 111 to the system bus 211. The network I/F 206 is connected to the LAN 100 and the system bus 211, and outputs/inputs information. A scanner I/F 207 corrects, processes, and edits image data received from the scanner unit 112. Note that the scanner I/F 207 has a function of determining whether the received image data is a color or monochrome original, whether the received image data is a character or photograph original, and the like.

An image processing unit 208 changes the direction of image data, compresses an image, performs decompression processing, and the like. Further, the image processing unit 208 can composite images stored in the HDD 204 so as to form one image. A printer I/F 209 receives image data sent from the image processing unit 208, and performs image processing on the image data with reference to attribute data accompanying this image data. The image data on which image processing has been performed is output to the printer unit 113.

Next is a description of the hardware configuration of the Web server 120. The Web server 120 is provided with a CPU 301, a RAM 302, a ROM 303, a network I/F 305, and a hard disk drive (HDD) 306, and the units are connected to each other via a system bus 309 such that communication is possible. Further, a display apparatus 307 such as a CRT, an input apparatus 304 such as a keyboard, and a pointing device 308 such as a mouse are connected to each other via the system bus 309 such that communication is possible.

Control programs for an operating system, a Web application, and the like are stored in the ROM 303 and the HDD 306. The CPU 301 reads those control programs from the ROM 303 or the HDD 306 onto the RAM 302 and executes the programs as necessary, thereby exhibiting the functions as a computer. Further, the CPU 301 displays various information via the display apparatus 307, and also accepts a user instruction and the like from the input apparatus 304 and the pointing device 308. Moreover, the CPU 301 communicates with other apparatuses connected to the LAN/WAN 101 via the network I/F 305. Devices that can communicate therewith include a LAN/WAN that can be connected to the LAN/WAN 101.

Software Configuration Diagram of MFP 110 and Web Server 120

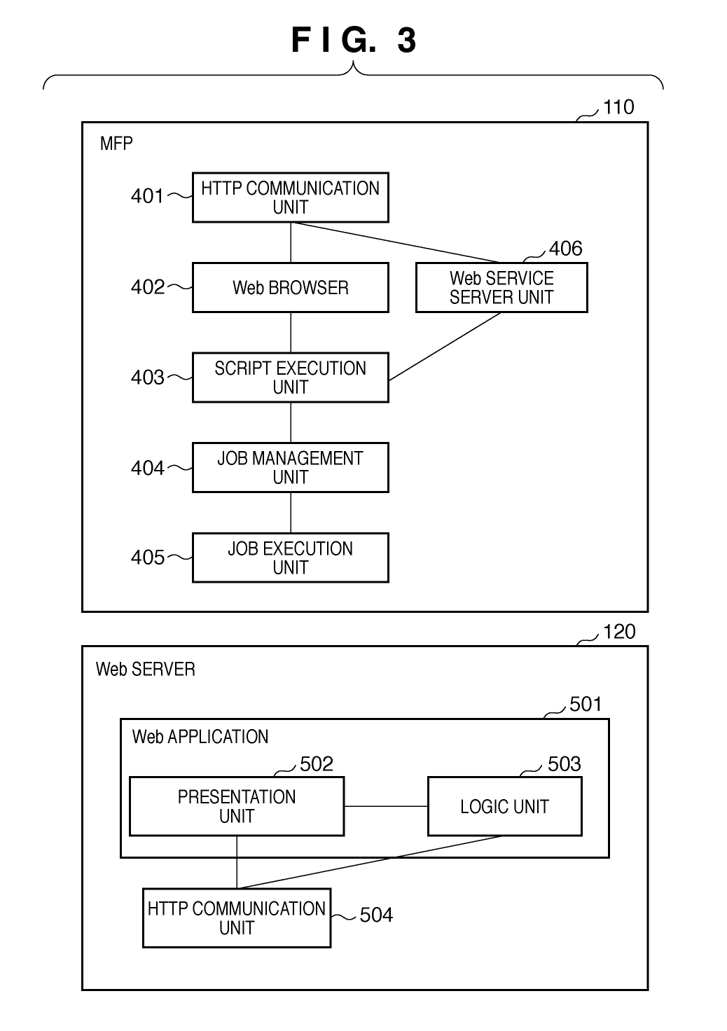

Next is a description of the software module configurations of the MFP 110 and the Web server 120 relating to communication processing in the present embodiment, with reference to FIG. 3. First is a description of software modules of the MFP 110. The software modules are stored in the HDD 204 of the MFP 110, and executed by the CPU 201.

An HTTP communication unit 401 is a software module that operates the network I/F 206 and performs communication using the HTTP protocol. A Web browser 402 is a Web browser that communicates with the Web server 120 via the HTTP communication unit 401. The Web browser 402 requests the Web server 120 for an operation screen described in HTML. Further, the Web browser 402 renders HTML data indicating an operation screen received from the Web server 120 via the HTTP communication unit 401 and displays the operation screen on the operation unit 111. Further, the Web browser 402 notifies the Web server 120 of an input with respect to the operation screen displayed on the operation unit 111.

A script execution unit 403 analyzes script information created by the Web server 120 and received via the Web browser 402, and divides the information into job information pieces included in the script. Then, the script execution unit 403 notifies a job management unit 404 to execute the job information pieces in the order designated in the script. Further, the script execution unit 403 can cause a Web service server unit 406 to provide an operation interface of the script execution unit as a Web service. Examples of the operation interface of the script execution unit 403 include an interface for obtaining the condition of a script, which includes the condition of a job that is being executed, and an operation interface for the control of a job managed by the job management unit 404. For example, a scan job includes the stop of scanning, the control of restarting after changing an original, and the like.

The job management unit 404 manages job information in response to instructions from the script execution unit 403, and instructs a job execution unit 405 to sequentially execute jobs. The job execution unit 405 is a module that executes job processing based on a job setting. For example, if the job is a scan job, the job execution unit 405 operates the scanner unit 112 so as to read a paper original, and stores image data in the HDD 204. In the case of a transmission job, the job execution unit 405 executes a job of operating the network I/F 206 and transmitting image data in the HDD 204. The Web service server unit 406 is a software module that has a server function of providing Web services. The Web service server unit 406 provides a Web service for operating the script execution unit 403 in response to an invocation from the script execution unit 403. Further, the Web service server unit 406 can invoke the script execution unit 403 according to the invoked Web service. Moreover, when detecting a firewall on a communication path, the Web service server unit 406 operates as a waiting server, and can receive a communication test packet transmitted by the Web server 120.

Next is a description of software modules of the Web server 120. The Web server 120 is provided with a Web application 501 and an HTTP communication unit 504. Moreover, the Web application 501 includes a presentation unit 502 and a logic unit 503. The software modules are stored in the HDD 306 of the Web server 120, and executed by the CPU 301.

The presentation unit 502 transmits an operation screen to be displayed by the Web browser 402 of the MFP 110 to the MFP 110 via the HTTP communication unit 504, in response to a request from the MFP 110. Further, the presentation unit 502 receives, from the MFP 110 via the HTTP communication unit 504, input information from a user input via the operation screen displayed by the Web browser 402 of the MFP 110.

The logic unit 503 performs processing on input information from the MFP 110 passed from the presentation unit 502. For example, the logic unit 503 changes the screen to be displayed according to an input from the user, and creates job definition information (script) for executing the device function of the MFP 110. The HTTP communication unit 504 is a software module that operates the network I/F 305 and performs communication using the HTTP protocol.

### First Embodiment

Capability Adjustment and Job Execution Flow

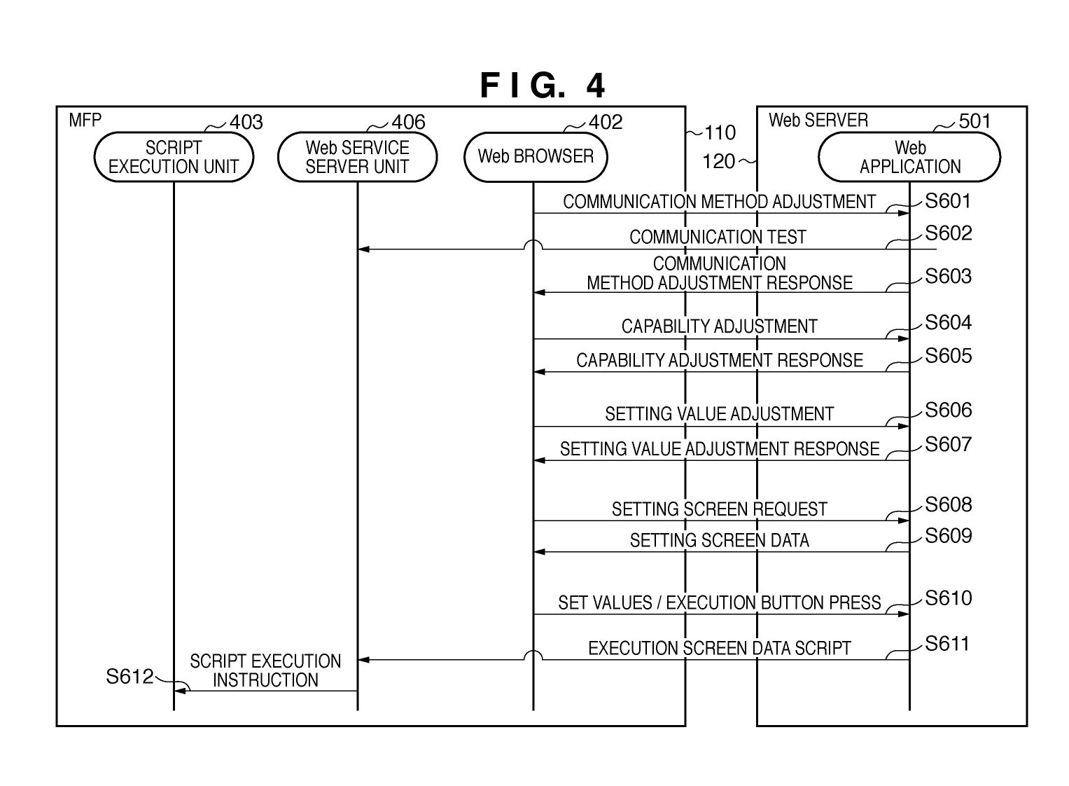

Below is a description of a first embodiment according to the present invention with reference to FIGS. 4 to 7. First is a description of job execution flow processing in a case where the Web server 120, which is an example of the information processing apparatus of the present invention, detects the firewall 130, with reference to FIG. 4. In order to obtain a setting screen for processing execution, the Web browser 402 requests the Web application 501 on the Web server 120 for such a setting screen. In the present embodiment, the MFP 110 is set in advance so as to request a URL that indicates content of a setting screen when started up.

First, in S601, before executing processing for communication with the Web server 120, the Web browser 402 of the MFP 110 establishes a communication method adjustment connection in order to detect a firewall on a communication path between the MFP 110 and the Web server 120. The Web browser 402 transmits a network packet to the Web server 120 in order to establish this connection. Moreover, the Web browser 402 requests the Web service server unit 406 to initialize an access point for waiting for a network packet to be used in a communication test that will be described later. The Web service server unit 406 initializes the access point for waiting, and enters a state of waiting for a network packet.

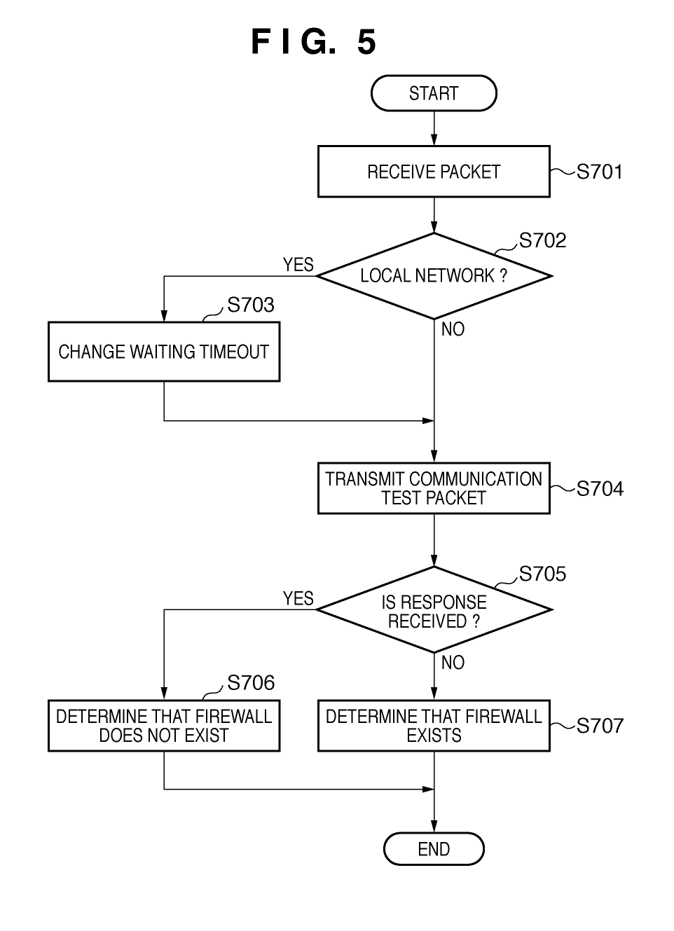

Upon receipt of a communication method adjustment connection, the Web application 501 of the Web server 120 conducts a communication test in S602. Here, a communication test in S602 will be described with reference to FIG. 5. The CPU 301 of the Web server 120 performs overall control of the flowchart in FIG. 5. The processing described below is an example of processing performed by a detection unit. In S701, upon receipt of the communication method adjustment connection in S601, the Web application 501 transitions to S702. In S702, the Web application 501 checks the address of the transmission source of that packet (that is, the address of the MFP 110), and determines whether or not this address is a local network address. A local address checking method is used in which it is determined whether the address is a local address using a private address prepared for each class in the case of IPv4. Specifically, the address range is 10.0.0.0 to 10.255.255.255 in the case of class A, the address range is 172.16.0.0 to 172.31.255.255 in the case of class B, and the address range is 192.168.0.0 to 192.168.255.255 in the case of class C. Further, in IPv6, link local addresses and site local addresses (use of which is not currently recommended) are handled as local network addresses. In other protocols, with regard to a protocol that has the concept of a local network as with the case of IP addresses, it is also determined whether or not an address is a local network address. Although local network determination is performed in the present embodiment, this determination processing does not necessarily need to be performed if there is leeway in the processing time, for instance.

If the Web application 501 determines that the transmitter belongs to a local network, the processing transitions to S703. In S703, the Web application 501 decreases a waiting timeout value. This timeout value is a timeout value for firewall search processing that will be described later. Although the timeout is set to 3 minutes by default, since the detected packet is transmitted from the MFP 110 on the local network, it is determined that communication can be performed in a shorter time, compared with a case of an apparatus outside the local network, and thus 3 minutes is changed to, for example, 1 minute so as to reduce the waiting time. Accordingly, a communication test can be conducted efficiently. When the Web application 501 changes the timeout value in S703, the processing transitions to S704. On the other hand, if the Web application 501 determines in S702 that the detected packet is not from the local network, the Web application 501 transitions to S704 without performing processing in S703.

In S704, the Web application 501 transmits a communication test packet to the MFP 110, and transitions to S705. This communication test packet is transmitted in order to perform another network connection, rather than in response to the communication method adjustment packet transmitted by the Web browser 402 in S601 described above. The transmission destination is the access point at which the Web service server unit 406 is waiting in S601 for a network packet with which to perform a new communication test.

In S705, the Web application 501 waits for a response from the MFP 110 within the predetermined time period. Upon receipt of the network packet transmitted from the Web application 501 at the access point at which the Web service server unit 406 was waiting in S601, the Web service server unit 406 immediately returns a response to the Web application 501. Upon receipt of this response, the Web application 501 transitions to S706. If a response comes back within the predetermined time period, the Web application 501 determines in S706 that communication from the Web application 501 to the MFP 110 has ended normally. As a result, the Web application 501 determines in S706 that there is no firewall on the communication path, sets existence/absence information indicating that a firewall does not exist on the communication path between the MFP 110 and the Web server 120, and ends the communication test in S602.

On the other hand, if waiting for a communication packet times out in S705, in other words, if a response is not received within the predetermined time period, the Web application 501 transitions to S707. The Web application 501 determines in S707 that communication from the Web application 501 to the MFP 110 did not end normally. As a result, the Web application 501 determines in S707 that a firewall exists on the communication path, sets existence/absence information indicating that a firewall exists on the communication path between the MFP 110 and the Web server 120, and ends the communication test in S602. Note that processing in S705 to S707 is an example of processing performed by a firewall determination unit.

The description will now return to FIG. 4. Upon the end of processing for detecting a firewall on the communication path in S602, the Web application transitions to S603. In S603, the Web application 501 adds existence/absence information that indicates the firewall detection result detected in S602 to the network packet transmitted by the MFP 110 in S601, and transmits the resultant packet as a response to the MFP 110. Upon receipt of information indicating existence of a firewall and a communication method from the Web server 120 in S603, the Web browser 402 performs capability adjustment in S604.

Here, the communication method indicates a method for communication between the MFP 110 and the Web server 120. Specifically, since a firewall does not exist on the communication path between the MFP 110 and the Web server 120, the communication method is adjusted to a communication method that employs a second communication method in which the Web server 120 is able to issue an instruction without needing a request from the MFP 110. The second communication method has a feature of performing bidirectional communication in which a network connection from the MFP 110 to the Web server 120 and a network connection from the Web server 120 to the MFP 110 are possible, for example.

First is a description of a sequence in a case where a firewall does not exist. If a firewall does not exist, in S604, the MFP 110 performs notification of an access point at which a session is established from the Web server 120, and performs capability adjustment for adjusting the capabilities of the MFP 110 (printing speed, number of prints, scanner presence/absence, and other executable functions). At the same time, the Web service server unit 406 of the MFP 110 performs initialization to enable the access point notified in S604 to be used, and starts waiting for a packet. At the same time, the Web service server unit 406 also performs initialization processing for enabling a script to be submitted to the script execution unit 403. Here, for example, the access point of the Web service server unit 406 created in S601 may be reused. If the access point is not reused, processing ends with regard to the access point of the Web service server unit 406 created in S601.

Next, in S604, the Web application 501 receives information indicating various capabilities from the MFP 110, and obtains processing that can be submitted to the MFP 110 based on setting values set in the Web server 120 in advance. Upon the obtaining of the processing that can be submitted, the Web application 501 transitions to S605, and transmits a response to the capability adjustment to the MFP 110. In this description, since a firewall does not exist between the MFP 110 and the Web server 120, all the functions can be used. If function restriction is to be performed when firewall connection is performed, information on functions to be used by the Web server 120 may be added to the capability adjustment response in S605. In this case, the MFP 110 restricts usable functions of the MFP 110 based on that capability adjustment response.

Next, in S606, the Web browser 402 obtains items that need to be adjusted in advance with the Web server 120 using the setting values of usable functions. These items are items determined in advance, and examples thereof include a connection timeout value, a UI timeout value, and the like. In S606, the Web browser 402 transmits the items that need to be adjusted to the Web application 501. Upon receipt of a setting value from the MFP 110 in S606, the Web application 501 compares the value in the Web application 501 therewith, and uses the value transmitted from the MFP 110. Although it is assumed in the present embodiment that the value transmitted from the MFP 110 is used as it is, the value may be adjusted using another method such as a method in which the Web server 120 performs readjustment. Subsequently, in S607, the Web application 501 transmits a response to the MFP 110, and the processing transitions to S608.

In S608 and subsequent steps, details of scan transmission processing implemented in the information processing system in the order in this sequence diagram will be described. Scan transmission processing is processing in which an original is read using the scanner unit 112 of the MFP 110 so as to generate image data, and the generated image data is transmitted to an FTP server (not shown) on the LAN 100 and the LAN/WAN 101. In the present embodiment, although capability adjustment described above is performed before performing various processes, a result obtained by performing adjustment once is stored as an adjustment result, and if processing is performed again, adjustment processing may be omitted. Moreover, capability adjustment may be implemented only when the system starts for the first time or capability adjustment may be performed again after a fixed time period has elapsed.

First, a user presses a button for executing the transmission function from the operation unit 111 of the MFP 110, thereby starting the Web browser 402. After that, in S608, the Web browser 402 requests the Web application 501 that holds content indicated by the above URL, using an HTTP GET command. Specifically, the Web browser 402 passes the URL to the HTTP communication unit 401. In response thereto, the HTTP communication unit 401 communicates with the HTTP communication unit 504 of the Web server 120 using the HTTP protocol. The HTTP communication unit 504 notifies an appropriate Web application of the request according to the received URL. Accordingly, a request is transmitted from the Web browser 402 to the Web application 501. The operation of the HTTP communication units 401 and 504 is omitted from the following description.

In S609, the presentation unit 502 of the Web application 501 creates HTML data indicating a setting screen (screen information) in response to the request in S608, and transmits the generated HTML data to the Web browser 402 as a response to the HTTP request. The Web browser 402 analyzes the received HTML data, and displays the setting screen on the operation unit 111.

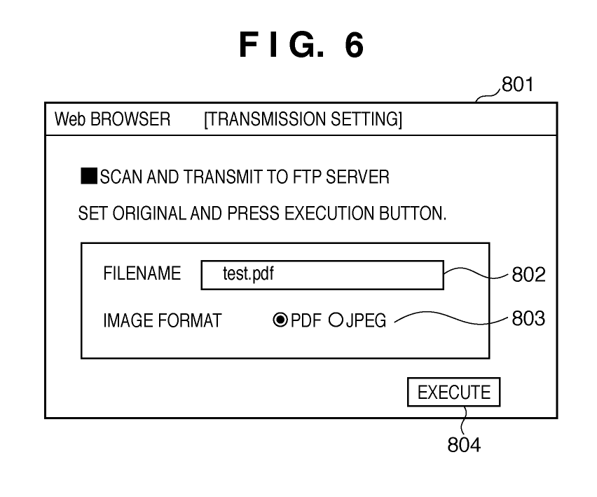

FIG. 6 shows an example of a setting screen displayed by the Web browser 402 using the HTML data received in S609. On a GUI panel 801, a text box 802 for setting a filename, and radio buttons 803 for selecting an image format are displayed. FIG. 6 shows a state where a filename “test.pdf” is given to image data, and the image data is set to be generated in PDF format. Further, the GUI button 804 is a button for instructing execution of a function, and instructs the start of scanning if the user presses that button.

The description will now return to FIG. 4. In S610, the Web browser 402 instructs the Web application 501 to execute processing. If the user presses the GUI button 804, the Web browser 402 notifies the Web application 501 of a parameter set in the text box 802 and a parameter set using the radio button 803. It is desirable to utilize, for communication, a POST command in the HTTP protocol.

Next, in S611, the presentation unit 502 of the Web application 501 creates HTML data indicating a screen currently being processed in response to the request in S610. Further, based on setting information included in the POST command in S610, the logic unit 503 generates a script for executing processing by the MFP 110. Then, a new network connection different from that for the request in S610 is established with respect to the Web service server unit 406 of the MFP 110. When this network connection is established, the screen currently being processed and the script are transmitted to the Web service server unit 406. The Web service server unit 406 divides the received HTTP response into the script and the HTML data indicating the screen currently being processed. In S612, the Web service server unit 406 transmits the script and the HTML data indicating the screen currently being processed to the script execution unit 403. The script execution unit 403 executes the received script, and at the same time, displays the HTML data indicating the screen currently being processed on the screen of the Web browser 402. Although a description has been given in the present embodiment assuming that the HTML data indicating the screen currently being processed is transmitted from the Web application 501, such a screen may be generated on the MFP 110 side.

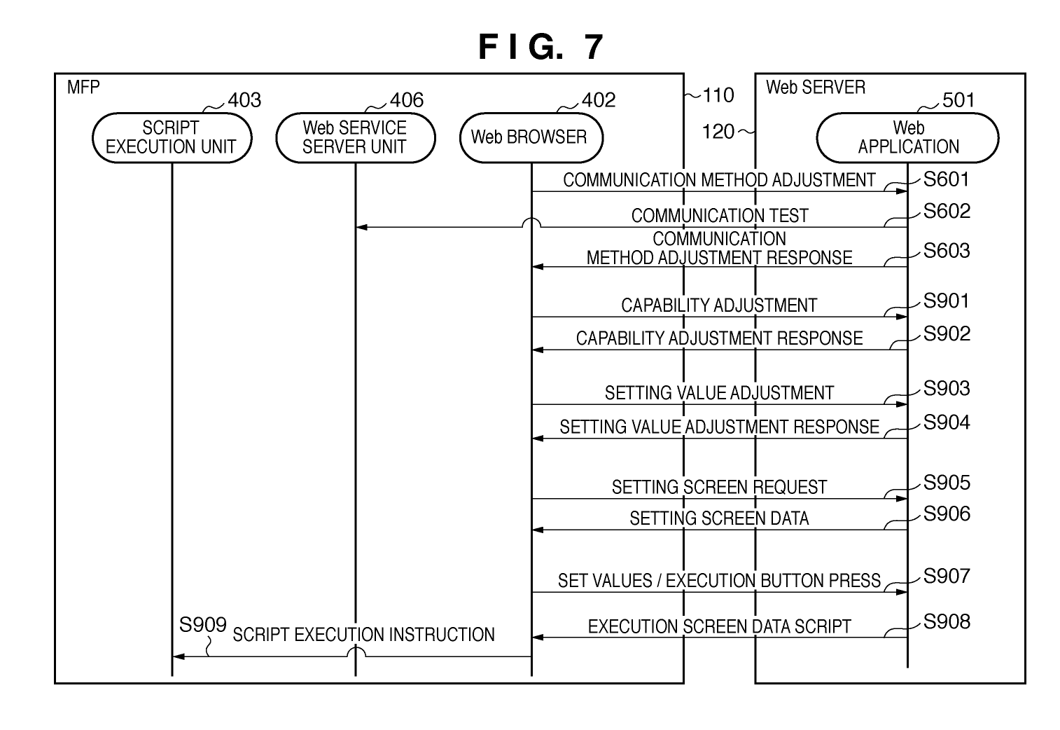

Next is a description of a sequence in a case where a firewall exists with reference to FIG. 7. The processing from S601 to S603 in the case where a firewall exists is the same as the processing in the case where a firewall does not exist, and thus a description thereof is omitted. Note that here, a firewall exists on the communication path between the MFP 110 and the Web server 120, and thus the communication method is adjusted to be a communication method that employs a first communication method in which the Web server 120 issues an instruction as a response to a request from the MFP 110. The first communication method has a feature of performing one-way communication in which only a network connection from the MFP 110 to the Web server 120 is possible, for example.

In S901, if a firewall exists, the Web browser 402 requests the Web service server unit 406 to perform processing for closing (ending) the access point of the Web service server unit 406 created in S601. The Web service server unit 406 performs processing for ending the created access point. Moreover, the Web browser 402 obtains the capabilities of the MFP 110 (printing speed, number of prints, scanner presence/absence, and other executable functions), and notifies the Web server 120 thereof.

Here, the Web application 501 receives information indicating various capabilities from the MFP 110, and obtains processing that can be submitted to the MFP 110 based on setting values set in advance. If a firewall exists, a network connection cannot be established from the Web application 501 to the MFP 110, and thus processing by the MFP 110 cannot be performed from the Web application 501, under the lead of the Web application 501. For example, in a case where the Web server 120 wants to cancel a copying operation that is being executed by the MFP 110, if there is no request from the MFP 110, the Web server 120 cannot submit a script for cancelling that copy processing. Accordingly, in the present embodiment, the copy function of the MFP 110 is prohibited. In S902, the Web application 501 transmits, to the MFP 110, a capability adjustment response with copy prohibition added thereto.

Upon receipt of the capability adjustment response in S902, the Web browser 402 of the MFP 110 performs copy prohibition processing, and the processing transitions to S903. In S903, the Web browser 402 obtains items that need to be adjusted in advance with the Web server 120, using the setting values of usable functions. These items are items determined in advance, and examples thereof include a connection timeout value, a UI timeout value, and the like. In S903, the Web browser 402 transmits the items that need to be adjusted to the Web application 501.

Upon receipt of a setting value from the MFP 110 in S903, the Web application 501 compares the value in the Web application 501 therewith, and uses the value transmitted from the MFP 110. Although it is assumed in the present embodiment that the value transmitted from the MFP 110 is used as it is, the value may be adjusted using another method such as a method in which the Web server 120 performs readjustment. Upon the end of adjustment of setting information in S903, the processing transitions to S904. In S904, the Web application 501 transmits a response to the MFP 110, and the processing transitions to S905.

In S905 and subsequent steps, details of scan transmission processing implemented in the information processing system in the order in this sequence diagram will be described. Scan transmission processing is processing in which an original is read using the scanner unit 112 of the MFP 110 so as to generate image data, and the generated image data is transmitted to an FTP server (not shown) on the LAN 100 and the LAN/WAN 101. In the present embodiment, although such capability adjustment is performed before performing various processes, if adjustment is performed once, the adjustment result thereof is stored, and adjustment does not need to be performed if processing is to be performed again. Moreover, capability adjustment may be implemented only when the system starts for the first time.

In S905, the Web browser 402 requests the Web application 501 that holds content indicated by the above URL, using an HTTP GET command. Specifically, the Web browser 402 passes the URL to the HTTP communication unit 401. In response thereto, the HTTP communication unit 401 communicates with the HTTP communication unit 504 of the Web server 120 using the HTTP protocol. The HTTP communication unit 504 notifies an appropriate Web application of the request according to the received URL. Accordingly, a request is transmitted from the Web browser 402 to the Web application 501. The operation of the HTTP communication units 401 and 504 is omitted from the following description.

Next, in S906, the presentation unit 502 of the Web application 501 creates HTML data indicating a setting screen in response to the request in S905, and transmits the created data to the Web browser 402 as an HTTP response. The Web browser 402 analyzes the received HTML data, and displays the setting screen shown in FIG. 6 on the operation unit 111.

Subsequently, in S907, the Web browser 402 instructs the Web application 501 to execute processing. If the user presses the GUI button 804, the Web browser 402 notifies the Web application 501 of a parameter set in the text box 802 and a parameter set using the radio button 803. It is desirable to utilize, for communication, a POST command in the HTTP protocol. In S908, the presentation unit 502 of the Web application 501 creates HTML data indicating a screen currently being processed in response to the request in S907. Further, based on setting information included in the POST command in S907, the logic unit 503 generates a script for executing processing by the MFP 110. After that, in S908, the Web application 501 transmits the screen currently being processed and the script to the Web browser 402 as an HTTP response. The Web browser 402 divides the received HTTP response into the script and the HTML data indicating the screen currently being processed. Further, in S909, the Web browser 402 transmits that script to the script execution unit 403. The script execution unit 403 executes the received script. Note that the Web browser 402 displays the HTML data indicating the screen currently being processed on its own screen.

As described above, according to the information processing system in the present embodiment, if a firewall does not exist on a communication path, a communication method is adjusted to be an optimal communication method for establishing a network connection from the Web server to the MFP. Accordingly, it is possible to submit a script to the MFP and display a screen thereon, under the lead of the Web server. On the other hand, even in the case where a firewall exists, a communication method is adjusted to be a communication method utilizing a network connection from the MFP, rather than the Web server and the MFP not being able to communicate with each other, and thus the Web server and the MFP communicate with each other, so as to enable script submission and screen display. Moreover, it is possible to detect a firewall before starting communication, determine a communication method depending on the detection result, adjust a usable capability, and adjust functions that cannot be used depending on the communication method. Moreover, unusable functions can be hidden on the screen, and thus it is possible to provide the user with only usable functions.

### Second Embodiment

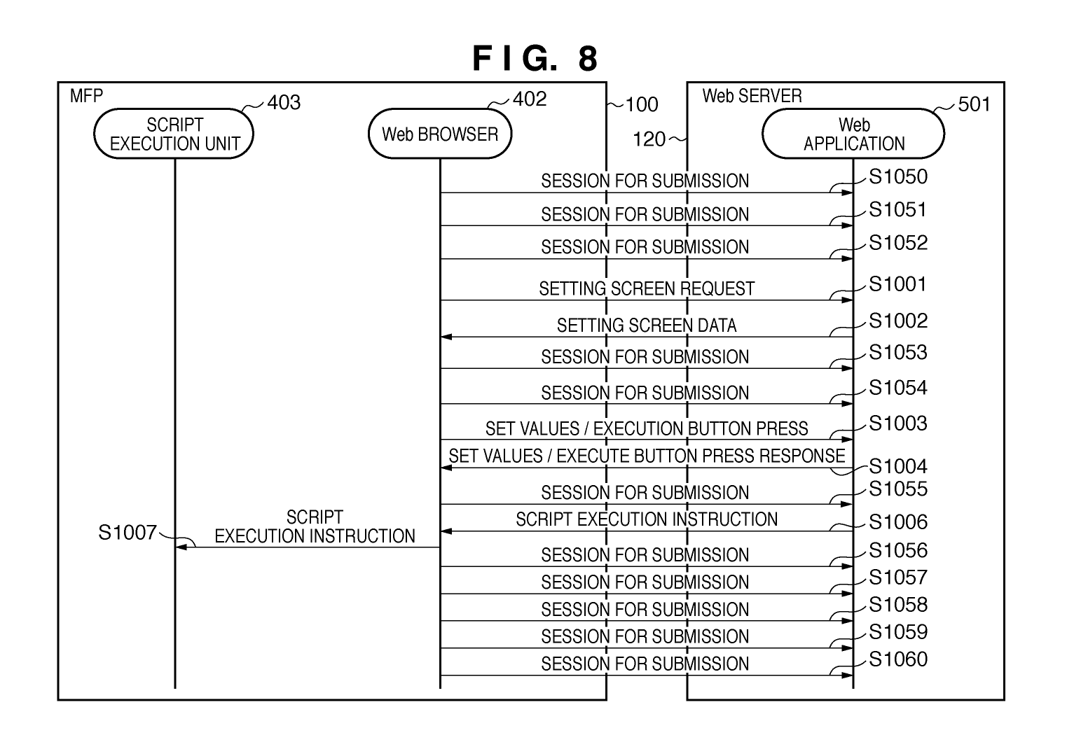

Next is a description of a second embodiment according to the present invention with reference to FIG. 8. The present embodiment describes a method different from that in the first embodiment in communication processing after the Web server 120, which is an example of an information processing apparatus of the present invention, detects the firewall 130.

The sequence in FIG. 8 shows processing after the adjustment of a communication method has already ended. Specifically, that processing is processing after a step corresponding to setting value adjustment response in S607 or S906 has ended.

In S1050 to S1060 shown in FIG. 8, the Web browser 402 periodically establishes a session for script submission with the Web server 120. The Web server 120 can submit a script in a case of operating the MFP 110, and transmit a screen to be displayed on the MFP, using such sessions. Although a description is given in the present embodiment using a method in which the Web browser 402 polls a session for script submission, the Web service server unit 406 described in the first embodiment may perform this operation. Moreover, a method may be adopted in which rather than performing polling, the Web browser 402 and the Web application 501 hold the session for job submission transmitted once until script submission, and establish a new session again if a script is submitted.

Upon the end of capability adjustment, in S1050, the Web browser 402 transmits a session for script submission to the Web server 120. If there are a script to be submitted to the MFP 110 and a screen to be displayed thereon, the Web server 120 transmits data indicating these as a response to the session for script submission. This session is ignored if there is no such script or screen. As another method, it is sufficient to notify that there is no data to be transmitted as a response. If there is no reply and a fixed time period has elapsed, the Web browser 402 cancels the session in S1050, and transmits a session for script submission again in S1051. In this way, in S1050 to S1060, the Web browser 402 repeatedly transmits a session for script submission for every fixed time period.

In the processing in S1001 to S1007, details of scan transmission processing implemented in the information processing system in the order in this sequence diagram will be described. Scan transmission processing is processing in which an original is read using the scanner unit 112 of the MFP 110 so as to generate image data, and the generated image data is transmitted to an FTP server (not shown) on the LAN 100 and the LAN/WAN 101. In the present embodiment, although capability adjustment described above is performed before performing various processes, if adjustment is performed once, the adjustment result thereof is stored, and adjustment does not need to be performed if processing is to be performed again. Moreover, capability adjustment may be implemented only when the system starts for the first time.

In S1001, the Web browser 402 requests the Web application 501 that holds content indicated by the above URL, using an HTTP GET command. Specifically, the Web browser 402 passes the URL to the HTTP communication unit 401. In response thereto, the HTTP communication unit 401 communicates with the HTTP communication unit 504 of the Web server 120 using the HTTP protocol. The HTTP communication unit 504 notifies an appropriate Web application of the request according to the received URL. Accordingly, a request is transmitted from the Web browser 402 to the Web application 501. The operation of the HTTP communication units 401 and 504 is omitted from the following description.

Next, in S1002, the presentation unit 502 of the Web application 501 creates HTML data indicating a setting screen in response to the request in S1001, and transmits the created data to the Web browser 402 as an HTTP response. The Web browser 402 analyzes the received HTML data, and displays the setting screen shown in FIG. 6 on the operation unit 111.

Subsequently, in S1003, the Web browser 402 instructs the Web application 501 to execute processing. If the user presses the GUI button 804, the Web browser 402 notifies the Web application 501 of a parameter set in the text box 802 and a parameter set using the radio button 803. It is desirable, for communication, to utilize a POST command in the HTTP protocol.

Next, in S1004, the presentation unit 502 of the Web application 501 creates HTML data indicating a screen currently being processed in response to the request in S1003. Further, based on setting information included in the POST command in S1003, the logic unit 503 generates a script for executing processing by the MFP 110. Then, in S1004, the Web application 501 transmits a screen currently being processed to the Web browser 402 as an HTTP response.

The Web browser 402 displays the received HTTP response on the screen of the Web browser 402. The script created by the logic unit 503 waits for a next script submission session. In the example in FIG. 8, if a script submission session is established from the Web browser 402 in S1055, the Web application 501 transmits, in S1005, the script created in S1004 in response to the session in S1055. The Web browser 402 transmits the script received in S1005 to the script execution unit 403 in S1006.

The script execution unit 403 executes the received script. Note that although the HTML data indicating the screen currently being processed was transmitted in S1004, that HTML data may be submitted together with the script in S1005. Moreover, although the Web browser 402 transmits only the script to the script execution unit 403, the Web browser 402 may transmit the HTML data indicating the screen currently being processed to the script execution unit 403 at the same time. In this case, the script execution unit 403 may display the HTML screen on the Web browser 402, the script execution unit 403 may create a screen, and display the created screen on the front face of the Web browser 402. Thus, the Web server 120 can submit a timely script due to a periodical request from the MFP 110. Accordingly, it is possible to realize control corresponding to that in the case where a firewall does not exist.

### Third Embodiment

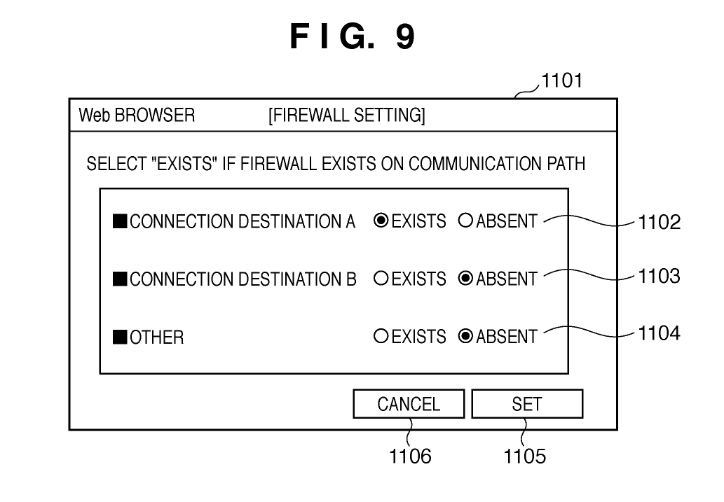

Next is a description of a third embodiment according to the present invention with reference to FIG. 9. The present embodiment describes processing in which the MFP 110, which is an example of an information processing apparatus of the present invention, detects a firewall. FIG. 9 shows an input screen for the user using the MFP 110 to input to the MFP whether there is a firewall on the communication path between the MFP and an apparatus that serves as a communication target. In a GUI screen 1101 of the MFP 110, data of the Web server 120 that has been registered as a connection destination of the MFP 110 is displayed in a list. According to the existence or absence of a firewall on a communication path between the MFP and each registered destination, the existence or absence of a firewall is registered by operating radio buttons 1102 to 1104. In the case of a connection destination A corresponding to 1102, since a firewall exists on the communication path, “exists” is selected. In the case of a connection destination B corresponding to 1103, since a firewall does not exist on the communication path, a radio button indicating “absent” is selected. Moreover, in the case of connecting to a server other than the connection destinations A and B, one of the buttons is selected for “other” corresponding to 1104.

If the settings are to be reflected, a setting button 1105 is pressed. If the settings are to be canceled, a cancel button 1106 is pressed. Although data is automatically displayed in a list in the present embodiment, a GUI in which a connection destination with a firewall is input and registered may be used. If the MFP 110 is to connect to the Web server 120, the Web server 120 is notified of the firewall settings set in this GUI screen 1101, thereby enabling the Web server 120 to detect a firewall. The processing flow after that is the same as that in the first and second embodiments, and thus a description thereof is omitted. Note that although the MFP 110 is provided with a GUI for firewall setting, a GUI for firewall setting for each MFP to connect may be provided on the Web server 120 side. Moreover, although the user makes an input in the GUI screen in the present embodiment, a method may be adopted in which a firewall on a communication path notifies the MFP 110 of the existence thereof.

### Other Embodiments

Aspects of the present invention can also be realized by a computer of a system or apparatus (or devices such as a CPU or MPU) that reads out and executes a program recorded on a memory device to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2010-153481 filed on Jul. 5, 2010, which is hereby incorporated by reference herein in its entirety.

What is claimed is:

1. An information processing system comprising an image processing apparatus and an information processing apparatus that are connected via a network,
the image processing apparatus including:
a request unit that requests the information processing apparatus for existence/absence information that indicates whether a firewall exists on a communication path between the image processing apparatus and the information processing apparatus, and
the information processing apparatus including:
a detection unit that detects whether a firewall exists on the communication path between the image processing apparatus and the information processing apparatus, in response to the request from the request unit;
an adjustment unit that adjusts a communication method so as to employ a first communication method in which the information processing apparatus issues an instruction as a response to a request from the image processing apparatus in a case where a detection result obtained by the detection unit indicates that the firewall exists, and so as to employ a second communication method in which the information processing apparatus issues an instruction without needing a request from the image processing apparatus in a case where the detection result does not indicate that the firewall exists; and
a notification unit that notifies the image processing apparatus of the communication method adjusted by the adjustment unit and the existence/absence information.

2. The information processing system according to claim 1,
wherein the detection unit includes:
a transmission unit that transmits to the image processing apparatus a test packet for determining whether communication is possible; and
a firewall determination unit that determines that a firewall does not exist on the communication path in a case where a response to the test packet transmitted by the transmission unit is received from the image processing apparatus within a predetermined time period, and determines that a firewall exists on the communication path in a case where the response is not received from the image processing apparatus within the predetermined time period.

3. The information processing system according to claim 2,
wherein the detection unit further includes:
a local network determination unit that determines whether the image processing apparatus serving as a transmission source of the request made by the request unit exists in a local network of the information processing apparatus; and
a reduction unit that reduces the predetermined time period in a case where the local network determination unit has determined that the image processing apparatus exists in the local network of the information processing apparatus.

4. The information processing system according to claim 1,
wherein the image processing apparatus further includes:
a capability adjustment unit that adjusts a function that is executable between the image processing apparatus and the information processing apparatus, according to the communication method adjusted by the adjustment unit.

5. The information processing system according to claim 1,
wherein the first communication method is one-way communication in which only a network connection from the image processing apparatus to the information processing apparatus is possible, and
the second communication method is bidirectional communication in which a network connection from the image processing apparatus to the information processing apparatus and a network connection from the information processing apparatus to the image processing apparatus are possible.

6. The information processing system according to claim 5,
wherein the image processing apparatus further includes:
a unit that periodically requests the information processing apparatus for an instruction when the image processing apparatus communicates with the information processing apparatus using the second communication method.

7. The information processing system according to claim 1,
wherein the image processing apparatus further includes:
a unit that displays an input screen for inputting information that indicates whether a firewall exists on a communication path between the image processing apparatus and an apparatus that serves as a communication target; and
a unit that transmits the information input via the input screen to the information processing apparatus that serves as the communication target, and
the detection unit, based on the information transmitted from the image processing apparatus, detects whether a firewall exists on the communication path between the image processing apparatus and the information processing apparatus.

8. An information processing apparatus connected to an image processing apparatus via a network, the information processing apparatus comprising:
a detection unit that detects whether a firewall exists on a communication path between the image processing apparatus and the information processing apparatus, in response to a request from the image processing apparatus;
an adjustment unit that adjusts a communication method so as to employ a first communication method in which the information processing apparatus issues an instruction as a response to a request from the image processing apparatus in a case where a detection result obtained by the detection unit indicates that the firewall exists, and so as to employ a second communication method in which the information processing apparatus issues an instruction without needing a request from the image processing apparatus in a case where the detection result does not indicate that the firewall exists; and
a notification unit that notifies the image processing apparatus of the communication method adjusted by the adjustment unit and existence/absence information that indicates whether a firewall exists on the communication path between the image processing apparatus and the information processing apparatus.

9. A control method for an information processing system including an image processing apparatus and an information processing apparatus that are connected via a network, the method comprising:
a request unit of the image processing apparatus requesting the information processing apparatus for existence/absence information that indicates whether a firewall exists on a communication path between the image processing apparatus and the information processing apparatus;
a detection unit of the information processing apparatus detecting whether a firewall exists on the communication path between the image processing apparatus and the information processing apparatus, in response to the request in the requesting;
an adjustment unit of the information processing apparatus adjusting a communication method so as to employ a first communication method in which the information processing apparatus issues an instruction as a response to a request from the image processing apparatus in a case where a detection result obtained in the detecting indicates that the firewall exists, and so as to employ a second communication method in which the information processing apparatus issues an instruction without needing a request from the image processing apparatus in a case where the detection result does not indicate that the firewall exists; and
a notification unit of the information processing apparatus notifying the image processing apparatus of the communication method adjusted in the adjusting and the existence/absence information.

10. A control method for an information processing apparatus connected to an image processing apparatus via a network, the method comprising:
a detection unit detecting whether a firewall exists on a communication path between the image processing apparatus and the information processing apparatus, in response to a request from the image processing apparatus;
an adjustment unit adjusting a communication method so as to employ a first communication method in which the information processing apparatus issues an instruction as a response to a request from the image processing apparatus in a case where a detection result obtained in the detecting indicates that the firewall exists, and so as to employ a second communication method in which the information processing apparatus issues an instruction without needing a request from the image processing apparatus in a case where the detection result does not indicate that the firewall exists; and
a notification unit notifying the image processing apparatus of the communication method adjusted in the adjusting and existence/absence information that indicates whether a firewall exists on the communication path between the image processing apparatus and the information processing apparatus.

11. A computer-readable storage medium storing a computer program for causing a computer to execute the control method for the information processing system according to claim 9.

12. A computer-readable storage medium storing a computer program for causing a computer to execute the control method for the information processing apparatus according to claim 10.
